(19) United States
(12) Patent Application Publication
(10) Pub. No.: US 2003/0145880 A1
(43) Pub. Date: Aug. 7, 2003

(54) Cleaning equipment for the cleaning of tanks

(76) Inventors: Erik Lund Jepsen, Vaerlose (DK); Klaus Thogersen, Charlottenlund (DK); Gunner Monrad Sie, Viriem (DK)

Correspondence Address: William J Sapone, Coleman Sudol Sapone, 714 Colorado Avenue, Bridgeport, CT, 06605-1601, US

(21) Appl. No.: 10/240,901

(22) PCT Filed: Apr. 5, 2001
(86) PCT No.: PCT/DK01/00230

(30) Foreign Application Priority Data
Apr. 6, 2000 (DK) PA 2000 00577

(51) Int. Cl. B08B 3/00

(52) U.S. Cl. 134/167 R; 134/171; 134/166 C; 134/180

(57) ABSTRACT

Within the foodstuffs, the pharmaceutical and corresponding industries, it is of the utmost importance that the insides of tanks and the equipment existing herein can be held completely clean without the risk of undesired bacterial growth, cross-contamination etc. Equipment for the cleaning of tanks comprises a submerged pipe with a nozzle head mounted on the bottom, through which nozzles cleaning fluid is sprayed from below and upwards, while at the same time the nozzles are rotated and turned around inside the tank. In order to ensure an effective cleaning of this submerged equipment, according to the invention this equipment is configured so that cleaning fluid is constantly led out over the pipe (7) which extends down into the tank. This leading-out (18, 19, 22) is effected partly via a channel (17) in the bearing bush (15) for the pipe (7) in the housing (4) for the formation of a film of fluid (19) on the pipe (7), and partly via a channel (16) or a separate nozzle (20) in the housing (4) for the formation of a cleaning jet (18, 22) directed towards the pipe (7).

### THE KNOWN TECHNIQUE

The invention concerns equipment for the cleaning of the inside of tanks and similar containers, said equipment being mounted on the top and comprising a motor in a housing in which there is suspended a pipe which extends into the tank and on which there is mounted a nozzle head, in that said motor rotates the pipe and the nozzle head at the same time that cleaning fluid is sprayed from one or more nozzles on the nozzle head towards the inside surfaces of the tank, while at the same time that cleaning fluid is applied to the pipe for the external cleaning of the pipe.

Cleaning equipment of this kind is used for the cleaning of tanks when they are empty, and will be able to be configured in accordance with a programme which is pre-set from the point of view of timing as well as the choice of cleaning pattern.

The equipment can be mounted either in a permanent manner or it can be mounted when taken into use.

The actual cleaning consists of the spraying out of cleaning fluid from one or more movable nozzles, so that the whole of the inside of the tank is flushed in a suitable cleaning pattern to ensure the best possible cleaning at the lowest possible consumption of cleaning fluid.

If there is a need for a complete cleaning of the tank and the cleaning equipment itself, the cleaning equipment must thus also be cleaned. This can be effected by means of a nozzle jet which also cleans the equipment present in the tank, or by means of special nozzles which spray cleaning fluid towards the equipment.

Such a cleaning aggregate mounted permanently on a tank is known from the description in FR 2 556 986 A1. This plant consists of a jet arrangement mounted on a vertical, rotating axle which is mounted inside the tank, and where there is also an annular chamber with stationary nozzle openings extending around the axle, so that the axle and the area over the chamber under the cover on which the equipment is mounted on the tank can be sprayed with fluid.

In many cases this cleaning is insufficient. First and foremost, the cleaning equipment extending into the tank, such as a cleaning boom with nozzles and the chamber with supply pipes, is in itself a problem, the reason being that there are parts which are unable to be sprayed, and herewith that there are areas which are not effectively cleaned.

To this can be added that the cleaning jets have a limited cleaning effect on the uppermost part of the pipe above the chamber, the reason being that the cleaning fluid is sprayed upwards, whereby the kinetic energy is reduced due to the encounter with the counter-wave brought about by the down-flowing liquid. The oppositely-directed flow of liquid thus reduces the effect of the cleaning.

### THE OBJECT OF THE INVENTION

It is the object of the invention to simplify and at the same time improve the cleaning of the equipment without reducing the effect of the cleaning of the inside of the tank, and according to the invention this is achieved by means of equipment where a fluid channel is configured in the housing to create a jet of fluid which is directed towards the pipe from above.

In this simple manner, the pipe is cleaned along the whole of its extent, in that the cleaning fluid in the form of a cleaning jet is supplied from above at the inlet of the pipe into the tank, and from here flushes around the pipe all the way from the suspension in the housing and downwards to the nozzle head during rotation of the pipe. This flow extends in one and the same direction, whereby maximum cleaning effect is achieved.

There is hereby achieved an effective cleaning of the equipment, which solely comprises the pipe without the need for specially-configured auxiliary arrangements with atomisers and/or jet arrangements etc. The risk of uncleaned surfaces and pockets which could form breeding grounds for bacteria is hereby reduced.

As disclosed in claim 2, by letting the cleaning fluid flow via the bearing bush in which the pipe is suspended in the housing, and providing a channel in the bush itself, the fluid will be led towards the slide surface of the bush and form a film of fluid which can seep down on the pipe. Moreover, the bearing will constantly be effectively flushed through so that impurities are rinsed out.

Moreover, a saving in cleaning fluid is effected, in that the outside of the pipe is flushed clean by a combination of a cleaning jet and a film of fluid which transports the impurities away. The fluid film will soften possible deposits, while the cleaning jet will detach the deposits which are thereafter transported away by the down-seeping fluid.

As disclosed in claim 3, by configuring the channel in the housing with decreasing cross-section towards the outlet opening, a nozzle effect is achieved for the formation of an effective jet with high cleaning effect.

As disclosed in claim 4, by allowing the wall of the channel in the housing to slope towards the outlet opening, the channel and the area reduction can easily be formed in the housing.

Finally, as disclosed in claim 5, it can be expedient to mount a nozzle in the housing, in that an effective cleaning of the pipe can hereby be achieved from above, where the deposits involved can be particularly difficult to remove.

### THE DRAWING

In the following, an example embodiment of the cleaning equipment according to the invention will be described in more detail with reference to the drawing, where

FIG. 1 shows the cleaning equipment, partly in section, mounted on a tank, and

FIG. 2 shows the housing on the equipment and the uppermost part of the pipe partly in section.

### DESCRIPTION OF THE EXAMPLE EMBODIMENT

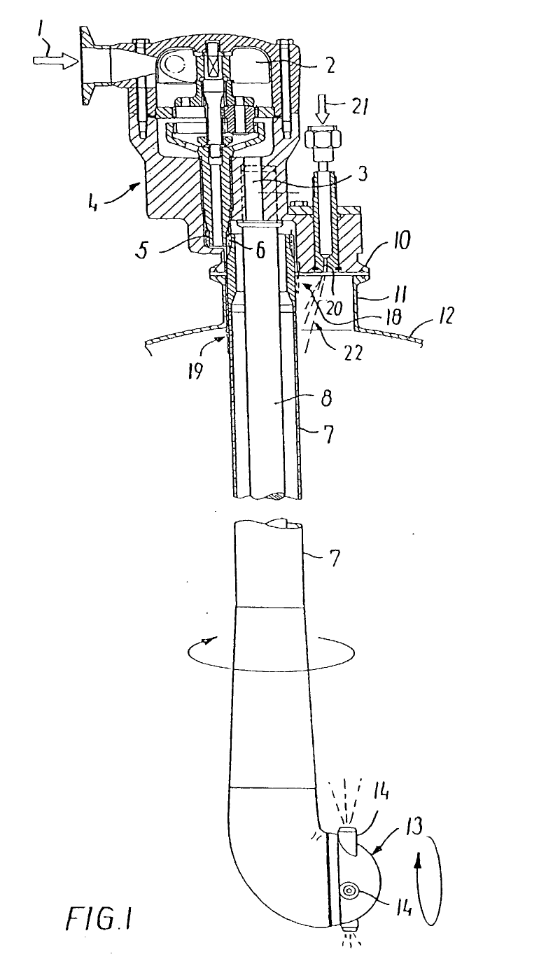

In FIG. 1 there is seen an example of an embodiment of the equipment mounted on a tank 12 with a mounting stub 11 with a flange 10.

The cleaning equipment itself is mounted on this stub 11 and the flange 10.

This equipment comprises a housing 4 with an inlet 1 for cleaning fluid under pressure, said fluid being led towards a turbine/blade wheel 2 in a hydraulic motor, which via a planetary gear turns a drive shaft 5 with external teeth on the lower part.

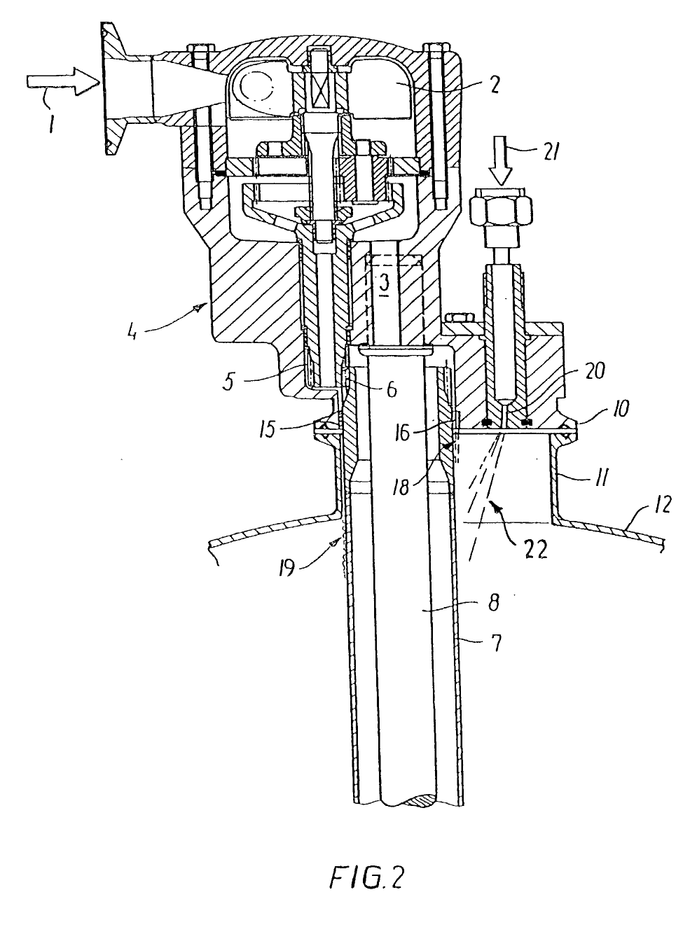

These teeth are in engagement with a gear ring 6 on a pipe 7 which is suspended in a bush 15, see FIG. 2, in the housing 4.

The bearing bush 15 is crimped to the pipe 7 or secured hereto in another manner.

Inside the pipe 7 there extends a fixed stay 8 which supports the rotating head 13 at its lower end, said head being provided with a number of nozzles 14 which, as indicated in FIG. 1, extend in a plane which is substantially parallel with the stay 8.

Between the pipe 7 and the rotating head 13 there is a not-shown gear transmission, so that when the pipe 7 turns, this turning movement is transferred to the rotating head 13, which is hereby made to turn as indicated with the rotation arrow.

When a cleaning of the tank is to be carried out after the tank has been emptied, pressure water 1 is supplied to the motor in which the turbine/blade wheel and planetary gear turn the pipe 7 with the rotating head 13, while at the same time that pressure fluid inside the housing 4 runs through the planetary gear and further partly around the drive shaft 5 and partly through a channel 3 to the inside of the pipe 7 around the stay 8.

This fluid ends down in the rotating head 13, and from here it is led through nozzles 14 out into the tank in the form of jets.

These jets sweep the inside of the tank in a pattern which is determined so that the whole of the tank space is swept in a manner whereby the cleaning becomes as effective as possible with the lowest possible consumption of fluid and energy.

As will appear especially from FIG. 2, the pipe 7 is provided with a bush 15 which is suspended in the housing 4. Fluid is also led to this annular slot space over the bush 15 via the narrowing-down on the uppermost part of the pipe 7, as indicated in FIG. 2.

As will appear from the sectional view in FIG. 2, the housing 4 is configured with a channel 16 which extends in an inclined manner at a small angle, hereby forming a nozzle opening and herewith a powerful jet 18 of fluid, as indicated in FIG. 2.

In the bush 15 there is also configured a channel on the outer side of the bush so that a supply of fluid to the slide surface of the bush is formed.

There is hereby achieved a seeping-out of fluid around the bush 15 which, as indicated in FIG. 2, will form a fluid flow 19 which will constitute a film of fluid over the whole of the outside of the pipe 7, and which herewith will flush the loosened dirt away from the pipe.

In this way it is possible to clean the pipe 7 without any risk of this cleaning not being effective, in that the cleaning fluid is applied over the whole of the rotating equipment, so that the risk of un-cleaned areas does not arise.

Consequently, since there are no concealed areas on the equipment, a correspondingly complete cleaning of the equipment will be effected at the same time as the cleaning of the inside of the tank.

To this can be added that the cleaning fluid, as well as driving the motor, also flushes through and lubricates all of the moving parts, hereby ensuring that the equipment has a long lifetime since all abrasive particles are rinsed out. At the same time herewith, an effective barrier against bacterial growth on the inside of the equipment is achieved.

Where very strongly-adhering deposits on the pipe are involved, an extra nozzle jet can be necessary. This jet 22, see FIGS. 1 and 2, can be established by means of an extra nozzle 20 which is mounted in the housing 4 at the side of the pipe 7, and such that the nozzle 20 opens out at the joint between the tank stub 11 and the housing 4.

This nozzle 20 has a separate supply 21 of fluid externally on the housing, and herewith outside the tank space. There is hereby achieved security for an effective cleaning inside the tank even when firmly-adhering particles are involved, whereby the demands concerning the keeping clean of tank systems within e.g. the foodstuffs and pharmaceutical industries are fulfilled.

1. Cleaning equipment for the cleaning of the insides of tanks and similar containers, said equipment being mounted at the top and comprising a motor in a housing in which a pipe is suspended and extends inside the tank and on which a nozzle head is mounted, where said motor rotates the pipe and the nozzle head at the same time that cleaning fluid is sprayed out from one or more nozzles on the nozzle head towards the inside surfaces of the tank, and at the same time that cleaning fluid is applied to the pipe for external cleaning of the pipe, characterised in that a fluid channel (16) is configured in the housing (4) for the formation of a jet of fluid (18,22) which is directed towards the pipe (7) from above.

2. Cleaning equipment according to claim 1, characterised in that the pipe (7) is suspended in the housing (4) in a bearing bush (15), and that in the bearing bush (15) there is configured a channel (17) for the leading-out of fluid and for the formation of a film (19) of fluid on the slide surface of the bush (15).

3. Cleaning equipment according to claim 1, characterised in that the internal cross-sectional area of the fluid channel (16) decreases towards the outlet, the nozzle opening.

4. Cleaning equipment according to claim 3, characterised in that the one side wall of the channel (16) extends at an acute angle towards the outlet, the nozzle opening.

5. Cleaning equipment according to claim 1, characterised in that the fluid channel consists of a nozzle (20) in the housing (4) for the formation of a jet of fluid (22) which is directed towards the pipe (7).
